(19) United States
(12) Patent Application Publication
(10) Pub. No.: US 2004/0201888 A1
(43) Pub. Date: Oct. 14, 2004

(54) Image pickup device and stereoscopic image generation device

(76) Inventor: Shoji Hagita, Kanagawa (JP)

Correspondence Address: FROMMER LAWRENCE & HAUG LLP, 745 FIFTH AVENUE, NEW YORK, NY, 10151, US

(21) Appl. No.: 10/818,987

(22) Filed: Apr. 6, 2004

(30) Foreign Application Priority Data
Apr. 8, 2003 (JP) P2003-104408

(51) Int. Cl. G02F 1/1335; G02B 27/22

(52) U.S. Cl. 359/462

(57) ABSTRACT

An image pickup device and a stereoscopic image generation device can obtain video signals necessary for a plurality of signal channels with ease in a simple manner. Video signals of channels that correspond only to light of the first optical image and that of the second optical image can be generated by converging the horizontal component L1 of light of the first optical image from the subject transmitted by means of a horizontal component polarizing filter 3 and polarizing filters HF1, HF3, HF5, . . . to the pixels on the odd first line V1OL1, the even first line V1EL1, the odd second line V1OL2, the even second line V1EL2, . . . of CCD 2 and converging the vertical component L2 of light of the second optical image from the subject by means of a vertical component polarizing filter 4 and polarizing filters HF2, HF4, HF6, . . . to the pixels on the odd first line V2OL1, the even first line V2EL1, the odd second line V2OL2, the even second line V2EL2, . . . , of CCD 2.

### BACKGROUND OF THE INVENTION

1. Field of the Invention

This invention relates to an image pickup device and a stereoscopic image generation device that can suitably be used for generating video signals necessary for two signal channels in order to produce a stereoscopic image.

2. Description of the Related Art

Video cameras provided with a solid state image pickup device, or a charge coupled device (CCD), are known for picking up an image of a subject and generating video signals (see, Japanese Patent Laid-Open No. 9-312849).

For a camera user to generate a stereoscopic image by means of video cameras of this type, he or she needs to place two video cameras at positions that are separated from each other by a distance corresponding to the parallax of the eyes of the human body relative to the subject to be shot and operate the video cameras so as to generate video signals for the left eye and video signals for the right eye respectively.

When generating video signals for the left eye and video signals for the right eye to be used for a stereoscopic image by means of two video cameras, certain requirements for shooting the subject need to be satisfied. However, it is not necessarily easy to satisfy the requirements for shooting the subject and the user of the video cameras can be forced to perform complex and cumbersome operations.

For example, the user of the video cameras has to do cumbersome operations in order to adjust the cameras for focal distance, aperture, zooming, color tone, brightness and other items. Additionally, the two video cameras can show variances in terms of performance. In short, it has been highly difficult to generate video signals for the left eye and video signals for the right eye necessary for producing a stereoscopic image by means of two video cameras.

### SUMMARY OF THE INVENTION

In view of foregoing, an object of this invention is to provide an image pickup device and a stereoscopic image generation device by means of which the camera user can obtain video signals necessary for a plurality of signal channels with ease in a simple manner.

In an aspect of the invention, the above object is achieved by providing an image pickup device comprising: an image pickup means having pixels arranged on an imaging plane to the number corresponding to integer times of a predetermined number of scanning lines; a first horizontal component polarizing means adapted to transmit the horizontal component of light of the first optical image from a subject; and a first vertical component polarizing means arranged at a position separated from the first horizontal component polarizing means by a predetermined distance and adapted to transmit the vertical component of light of the second optical image from the subject; the horizontal component transmitted by the first horizontal component polarizing means being converged to the pixels in a predetermined area on the imaging plane; the vertical component transmitted by the first vertical component polarizing means being converged to the pixels in the remaining area excluded from the predetermined area.

With this arrangement, it is now possible to generate video signals of the channels that correspond only to light of the first optical image and that of the second optical image by converging only the horizontal component of light of the first optical image from the subject only to the pixels in a predetermined area on the imaging plane of the image pickup means by means of the first horizontal component polarizing means and, at the same time, converging only the vertical component of light of the second optical image from the subject only to the pixels in the remaining area excluded from the predetermined area on the imaging plane of the image pickup means.

In another aspect of the invention, there is provided a stereoscopic image generation device comprising: an image pickup device having an image pickup means having pixels arranged on an imaging plane to the number corresponding to integer times of a predetermined number of scanning lines, a first horizontal component polarizing means adapted to transmit the horizontal component of light of the first optical image from a subject for generating video signals for the left eye and a first vertical component polarizing means arranged at a position separated from the first horizontal component polarizing means by a predetermined distance and adapted to transmit the vertical component of light of the second optical image from the subject for generating video signals for the right eye, the horizontal component transmitted by the first horizontal component polarizing means being converged to the pixels in a predetermined area on the imaging plane, the vertical component transmitted by the first vertical component polarizing means being converged to the pixels in the remaining area excluded from the predetermined area; a signal processing means for processing the video signals for the left eye and the video signals for the right eye generated by the image pickup device in order to display an image on a predetermined display section by means of the signals; and a control means for alternately outputting the video signals for the left eye and the video signals for the right eye as processed by the signal processing means for a stereoscopic image by switching from the former to the latter and vice versa at predetermined time intervals.

Video signals for the left eye and video signals for the right eye can be used to display a stereoscopic image by generating the video signals for the left eye and the video signals for the right eye corresponding respectively to light of the first optical image and that of second optical image, performing a predetermined processing operation on the video signals for the left eye and the video signals for the right eye and then alternately outputting the video signals for the left eye and the video signals for the right eye by switching from the former to the latter and vice versa at predetermined time intervals when the horizontal component transmitted by the first horizontal component polarizing means is converged to the pixels in a predetermined area on the imaging plane of the image pickup means and the vertical component transmitted by the first vertical component polarizing means is converged to the pixels in the remaining area of the imaging plane of the image pickup means excluded from the predetermined area.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic perspective view of an image pickup device according to the invention that is adapted to interlaced scanning;

FIG. 2 is a schematic diagram illustrating the imaging plane of the CCD of an image pickup device according to the invention that is adapted to interlaced scanning;

FIG. 3 is a schematic perspective view of an image pickup device according to the invention that is adapted to progressive scanning;

FIG. 4 is a schematic diagram illustrating the imaging plane of the CCD of an image pickup device according to the invention that is adapted to progressive scanning;

FIG. 5 is a schematic block diagram of a stereoscopic image generation device according to the invention, showing the circuit configuration thereof;

FIG. 6 is a schematic view of a known 2 CCD type image pickup device;

FIG. 7 is a schematic view of another embodiment of image pickup device according to the invention, which is of the 3-CCD type;

FIGS. 8A to 8C are schematic diagrams illustrating the imaging plane of the CCD of still another embodiment of image pickup device according to the invention, which is of the 3-CCD type; and

FIG. 9 is a schematic block diagram of still another embodiment of image pickup device according to the invention, which is of the 3-CCD type, showing the circuit configuration thereof.

### DESCRIPTION OF THE PREFERRED EMBODIMENTS

Preferred embodiment of this invention will be described with reference to the accompanying drawings:

Firstly, an embodiment of the invention will be described in detail.

### (1) Configuration of Image Pickup Device

(1-1) Image Pickup Device Adapted to Interlaced Scanning

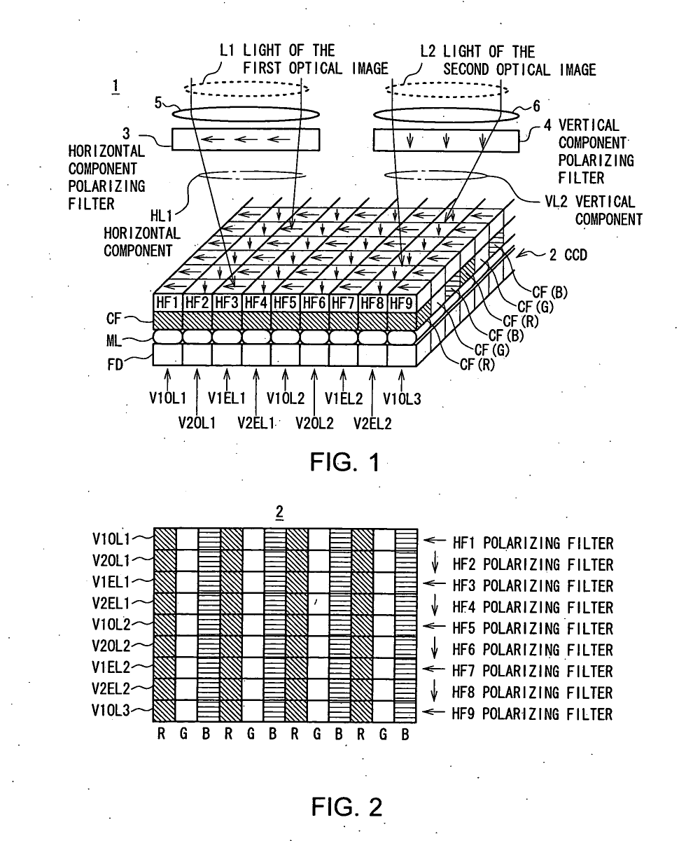

Referring to FIG. 1, reference symbol 1 generally denotes the illustrated embodiment of image pickup device that is adapted to interlaced scanning and comprises a solid state image pickup device (to be referred to as CCD hereinafter) 2 having pixels whose number (1050) corresponds to twice of the number (525) of scanning lines of the National Television System Committee (NTSC) system, a horizontal component polarizing filter 3 and a vertical component polarizing filter 4, the horizontal and vertical component polarizing filters 3 and 4 being separated from the imaging plane of the CCD 2 by a predetermined distance and from each other by a distance corresponding to the parallax of the eyes of the human body and combined with respective lenses 5 and 6.

The image pickup device 1 is adapted to transmit only the horizontal component HL1 of light L1 of the first optical image and converge it onto the imaging plane of the CCD 2 by means of the lens 5 and the horizontal component polarizing filter 3 and transmit only the vertical component VL2 of light L2 of the second optical image and converge it onto the imaging plane of the CCD 2 by means of the lens 6 and the vertical component polarizing filter 4.

The CCD 2 has pixels to the number (1050) corresponding to twice of the number of scanning lines of the National Television System Committee (NTSC) system and is adapted to, generate first channel video signals (odd field video signals, even field video signals) for the left eye and second channel video signals (odd field video signals, even field video signals) for the right eye in order to produce a stereoscopic image.

More specifically, as shown in FIG. 2, the CCD 2 has an odd first line V1OL1 for first channel video signals, an odd first line V2OL1 for second channel video signals, an even first line V1EL1 for first channel video signals, an even first line V2EL1 for second channel video signals, an odd second line V1OL2 for first channel video signals, an odd second line V2OL2 for second channel video signal, an even second line V1EL2 for first channel video signal, an even second line V2EL2 for second channel video signals, . . .

Thus, in the CCD 2 the odd first line V1OL1 for first channel video signals for the left eye, the even first line V1EL1 for first channel video signals, the odd second line V1OL2 for first channel video signals, the even second line V1EL2 for first channel video signals, . . . , which are every other scanning lines in the above described line arrangement, correspond to first channel video signals for the left eye.

Note that odd field video signals are formed for the odd first line V1OL1, the odd second line V1OL2, the odd third line V1OL3, . . . as first channel video signals for the left eye and even field videos signals are formed for the even first line V1EL1, the even second line V1EL2, the even third line V1EL3, . . . also as first channel video signals for the left eye.

Similarly, in the CCD 2, the odd first line V2OL1 for second channel video signals, the even first line V2EL1 for second channel video signals, the odd second line V2OL2 for second channel video signals, the even second line V2EL2 for second channel video signals, . . . , which are every other scanning lines in the above described line arrangement, correspond to second channel video signals for the right eye.

In this case again, odd field video signals for the odd first line V2OL1, the odd second line V2OL2, the odd third line V2OL3, . . . are formed as second channel video signals and even field video signals are formed for the even first line V2EL1, the even second line V2EL2, the even third line V2EL3, . . . also as second channel video signals.

In practice, photodiodes FD are arranged in the CCD 2 to constitute a number of pixels corresponding to the (525) scanning lines that correspond to first channel video signals for the left eye and also a number of pixels corresponding to the (525) scanning lines that correspond to second channel video signals for the right eye.

Additionally, micro-lenses ML are arranged in the CCD 2 for the photodiodes FD in order to converge the horizontal component HL1 of light L1 of the first optical image and the vertical component VL2 of light L2 of the second optical image onto the photodiode FD for the purpose of improving the sensitivity of the CCD 2 and color filters CF of R (red), G (green), and B (blue) are sequentially arranged also in the CCD for the micro-lenses ML. While the R, G and B color filters CF may be replaced by color filters of cyan, magenta and yellow, which are respective complementary colors, the present invention will be described hereinafter in terms of R, G and B color filters CF.

Furthermore, in the CCD 2, polarizing filters HF1, HF3, HF5, HF7, HF9, . . . are arranged in front of the respective color filters CF in order to transmit only the horizontal component HL1 of light L1 of the first optical image for the scanning lines for first channel video signals for the left eye, including the odd first line V1OL1, the even first line V1EL1, the odd second line V1OL2, the even second line V1EL2, Similarly, in the CCD 2, polarizing filters HF2, HF4, HF6, HF8, . . . are arranged in front of the respective color filters CF in order to transmit only the vertical component VL2 of light L2 of the second optical image for the scanning lines for second channel video signals for the right eye, including the odd first line V2OL1, the even first line V2EL1, the odd second line V2OL2, the even second line V2EL2,.

With this arrangement, the polarizing filters HF1, HF3, HF5, HF7, HF9, . . . transmit only the horizontal component HL1 of light L1 of the first optical image like the horizontal component polarizing filter 3 and irradiate the horizontal component HL1 onto the photodiodes FD that correspond to the scanning lines for first channel video signals for the left eye, including the odd first line V1OL1 the even first line V1EL1, the odd second line V1OL2, the even second line V1EL2, . . . .

Similarly, the polarizing filters HF2, HF4, HF6, HF8, . . . transmit only the vertical component VL2 of light L2 of the second optical image like the vertical component polarizing filter 4 and irradiate the vertical component VL2 onto the photodiodes FD that correspond to the scanning lines for second channel video signals for the right eye, including the odd first line V2OL1, the even first line V2EL1, the odd second line V2OL2, the even second line V2EL2, . . .

Thus, in the CCD 2, only the horizontal component HL1 of light L1 of the first optical image coming from the subject strikes the odd first line V1OL1 the even first line V1EL1, the odd second line V1OL2, the even second line V1EL2, . . . for first channel video signals by way of the lens 5, the horizontal component polarizing filter 3 and the polarizing filters HF1, HF3, HF5, HF7, HF9, . . . so that the CCD 2 can generate and output first channel video signals (odd field video signals, even field video signals) for the left eye.

Similarly, in the CCD 2, only the vertical component VL2 of light L2 of the second optical image coming from the subject strikes the odd first line V2OL1, the even first line V2EL1, the odd second line V2OL2, the even second line V2EL2, . . . for second channel video signals by way of the lens 6, the vertical component polarizing filter 4 and the polarizing filters HF2, HF4, HF6, HF8, . . . so that the CCD 2 can generate and output second channel video signals (odd field video signals, even field video signals) for the right eye.

(1-2) Image Pickup Device Adapted to Progressive Scanning

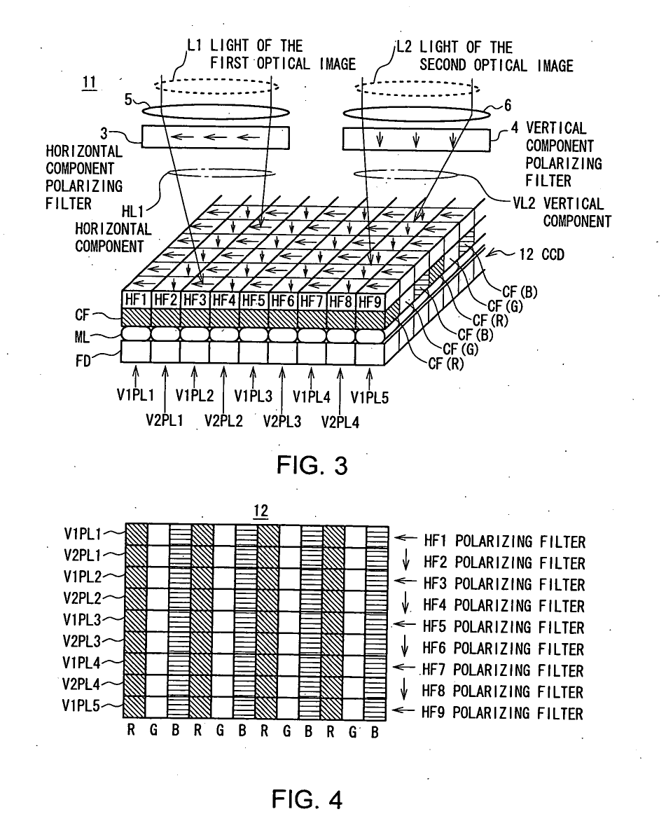

Referring now to FIG. 3, in which the components corresponding to their counterparts are denoted respectively by the same reference symbols, reference symbol 11 generally denotes the illustrated embodiment of image pickup device that is adapted to progressive scanning and comprises a CCD 12 having pixels whose number (1050) corresponds to twice of the number (525) of scanning lines of the National Television System Committee (NTSC) system, a horizontal component polarizing filter 3 and a vertical component polarizing filter 4, the horizontal and vertical component polarizing filters 3 and 4 being separated from the imaging plane of the CCD 12 by a predetermined distance and from each other by a distance corresponding to the parallax of the eyes of the human body and combined with respective lenses 5 and 6.

The image pickup device 11 is adapted to transmit only the horizontal component HL1 of light L1 of the first optical image from the subject and converge it onto the imaging plane of the CCD 12 by means of the lens 5 and the horizontal component polarizing filter 3 and transmit only the vertical component VL2 of light L2 of the second optical image from the subject and converge it onto the imaging plane of the CCD 12 by means of the lens 6 and the vertical component polarizing filter 4.

In this instance again, the CCD 12 has pixels to the number (1050) corresponding to twice of the number of scanning lines of the NTSC system and is adapted to generate first channel video signals (odd field video signals, even field video signals) for the left eye and second channel video signals (odd field video signals, even field video signals) for the right eye in order to produce a stereoscopic image.

More specifically, as shown in FIG. 4, the CCD 12 has a first line V1PL1 for first channel video signals, a first line V2PL1 for second channel video signals, a second line V1PL2 for first channel video signals, a second line V2PL2 for second channel video signals, a third line V1PL3 for first channel video signals, a third line V2PL3 for second channel video signals, a fourth line V1PL4 for first channel video signals, a fourth line V2PL4 for second channel video signals, . . .

Thus, in the CCD 12, the first line V1PL1 for first channel video signals for the left eye, the second line V1PL2 for first channel video signals, the third line V1PL3 for first channel video signals, the fourth line V1PL4 for first channel video signals, . . . , which are every other scanning lines in the above described line arrangement, correspond to first channel video signals for the left eye that are adapted to progressive scanning.

Similarly, in the CCD 12, the first line V2PL1 for second channel video signals for the right eye, the second line V2PL2 for second channel video signals, the third line V2PL3 for second channel video signals, the fourth line V2PL4 for second channel video signals, . . . , which are every other scanning lines in the above described line arrangement, correspond to second channel video signals for the right eye that are adapted to progressive scanning.

In practice, photodiodes FD are arranged in the CCD 12 to constitute a number of pixels corresponding to the (525) scanning lines that correspond to first channel video signals for the left eye and also a number of pixels corresponding to the (525) scanning lines that correspond to second channel video signals for the right eye. Then, micro-lenses ML are arranged in front of the respective photodiodes FD.

Furthermore, in the CCD 12, polarizing filters HF1, HF3, HF5, HF7, HF9, . . . are arranged in front of the respective color filters CF in order to transmit only the horizontal component HL1 of light L1 of the first optical image for the scanning lines for first channel video signals for the left eye, including the first line V1PL1, the second line V1PL2, the third line V1PL3, the fourth line V1PL4, . . . .

Similarly, in the CCD 12 polarizing filters HF2, HF4, HF6, HF8, . . . are arranged in front of the respective color filters CF in order to transmit only the vertical component VL2 of light L2 of the second optical image for the scanning lines for second channel video signals for the right eye, including the first line V2PL1, the second line V2PL2, the third line V2PL3, the fourth line V2PL4, . . . .

With this arrangement, the polarizing filters HF1, HF3, HF5, HF7, HF9, . . . transmit only the horizontal component HL1 of light L1 of the first optical image like the horizontal component polarizing filter 3 and irradiate the horizontal component HL1 onto the photodiodes FD that correspond to the scanning lines for first channel video signals for the left eye, including the first line V1PL1, the second line V1PL2, the third line V1PL3, the fourth line V1PL4, . . . .

Similarly, the polarizing filters HF2, HF4, HF6, HF8, transmit only the vertical component VL2 of light L2 of the second optical image like the vertical component polarizing filter 4 and irradiate the vertical component VL2 onto the photodiodes FD that correspond to the scanning lines for second channel video signals for the right eye, including the first line V2PL1, the second line V2PL2, the third line V2PL3, the fourth line V2PL4, . . . .

Thus, in the CCD 12, only the horizontal component HL1 of light L1 of the first optical image coming from the subject strikes the first line V1PL1, the second line V1PL2, the third line V1PL3, the fourth line V1PL4, . . . for first channel video signals by way of the lens 5, the horizontal component polarizing filter 3 and the polarizing filters HF1, HF3, HF5, HF7, HF9, . . . so that the CCD 12 can generate and output first channel video signals for the left eye (for 525 scanning lines) that correspond to progressive scanning.

Similarly, in the CCD 12, only the vertical component VL2 of light L2 of the second optical image coming from the subject strikes the first line V2PL1, the second line V2PL2, the third line V2PL3, the fourth line V2PL4, . . . for second channel video signals by way of the lens 6, the vertical component polarizing filter 4 and the polarizing filters HF2, HF4, HF6, HF8, . . . so that the CCD 12 can generate and output second channel video signals for the right eye (for 525 scanning lines) that correspond to progressive scanning.

### (2) Stereoscopic Image Generation Device

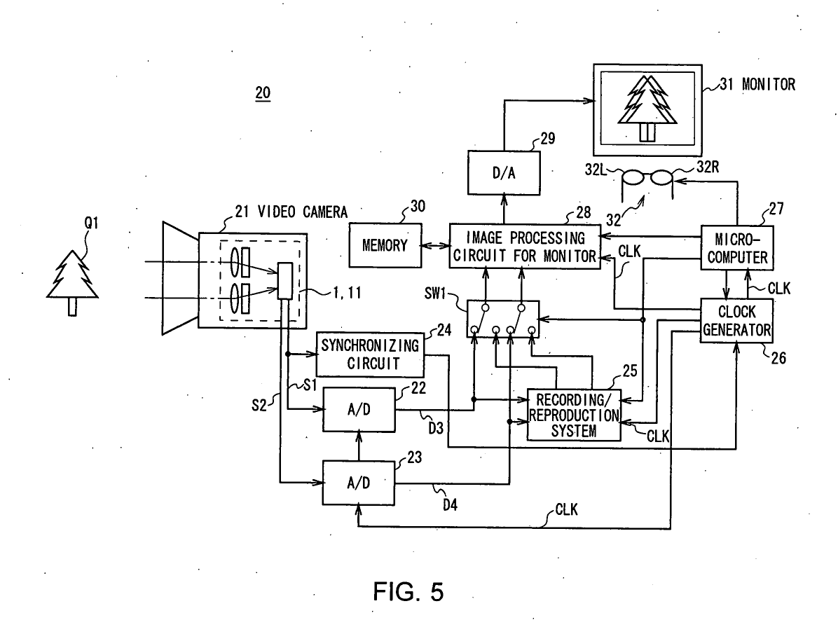

Now, the circuit configuration of a stereoscopic image generation device 20 adapted to generate a stereoscopic image by means of a video camera 21 comprising an image pickup device 1 (see FIGS. 1 and 2) according to the invention that corresponds to interlaced scanning or an image pickup device 11 (see FIGS. 3 and 4) according to the invention that corresponds to progressive scanning will be described by referring to FIG. 5.

The illustrated stereoscopic image generation device 20 transmits the first channel video signal S1 for the left eye and the second channel video signal S2 for the right eye obtained by shooting a subject Q1 by means of the image pickup device 1 or 11 of the video camera 21 respectively to analog/digital converter circuits 22 and 23 at the same time and also transmits the first channel video signal S1 for the left eye to synchronizing circuit 24.

While the video camera 21 transmits the first channel video signal S1 for the left eye to the synchronizing circuit 24 in the above description, it may alternatively be so arranged that the video camera 21 transmits the second channel video signal S2 for the right eye to the synchronizing circuit 24 instead of the first channel video signal S1 for the left eye.

The synchronizing circuit 24 generates a synchronizing signal that is synchronized with the first channel video signal S1 for the left eye according to the first channel video signal S1 and transmits it to clock generator 26.

The clock generator 26 generates a system clock CLK having a predetermined frequency according to the synchronizing signal supplied from the synchronizing circuit 24 and outputs it to microcomputer 27.

Then, the microcomputer 27 operates according to the system clock CLK supplied from the clock generator 26 and controls the clock generator 26, recording/reproduction system 25, live/video switch SW1, image processing circuit 28 for the monitor and eye-glasses-type stereoscopic image display device 32.

For example, when the live mode is selected to output the first channel video signal S1 for the left eye and the second channel video signal S2 for the right eye obtained by the video camera 21 in response to an operation of'shooting the subject of the video camera 21 performed by a user, the microcomputer 27 supplies a system clock CLK to the analog/digital converter circuits 22 and 23 by way of the clock generator 26. However, it is so arranged that the supply of the system clock CLK to the recording/reproduction system 25 is suspended at this time.

The analog/digital converter circuit 22 processes the first channel video signal S1 for the left eye supplied from the video camera 21 for analog/digital conversion and transmits the obtained first channel video data D3 for the left eye to the recording/reproduction system 25 and also to the image processing circuit 28 for the monitor by way of the live/video switch SW1.

The analog/digital converter circuit 23 processes the second channel video signal S2 for the right eye supplied from the video camera 21 for analog/digital conversion and transmits the obtained second channel video data D4 for the right eye to the recording/reproduction system 25 and also to the image processing circuit 28 for the monitor by way of the live/video switch SW1.

The recording/reproduction system 25 is adapted to record the first channel video data D3 for the left eye and the second channel video data D4 for the right eye, using a recording medium, which may be a hard disk, a digital versatile disc (DVD), a magneto optical disc (MO) or a video tape.

When the video mode is selected by the user, the recording/reproduction system 25 reproduces the first channel video data D3 for the left eye and the second channel video data D4 for the right eye and transmits them to the image processing circuit 28 for the monitor by way of the live/video switch SW1 under the control of the microcomputer 27.

When the live mode is selected by the user, the microcomputer 27 turns the live/video switch SW1 to the side of the analog/digital converter circuits 22 and 23.

When, on the other hand, the video mode is selected by the user so as to output the first channel video data D3 for the left eye and the second channel video data D4 for the right eye obtained by replaying the recording medium by means of the recording/reproduction system 25 to the monitor 21 as video signals, it turns the live/video switch SW1 to the side of the recording/reproduction system 25.

Then, as a result, the live/video switch SW1 transmits the first channel video data D3 for the left eye and the second channel video data D4 for the right eye supplied from the analog/digital converter circuits 22 and 23 or the first channel video data D3 for the left eye and the second channel video data D4 for the right eye reproduced from the recording/reproduction system 25 to the image processing circuit 28 for the monitor.

The image processing circuit 28 for the monitor is adapted to process the first channel video data D3 for the left eye and the second channel video data D4 for the right eye for digital/analog conversion by means of digital/analog conversion circuit 29 under the control of the microcomputer 27 and subsequently regulate the timing of outputting the corresponding images to and displaying them on a monitor 31. Thus, it outputs an image for the left eye and an image for the right eye that correspond respectively to the first channel video data D3 for the left eye and the second channel video data D4 for the right eye to the monitor 31 at the regulated timing.

Note that the image processing circuit 28 for the monitor can temporarily store the first channel video data D3 for the left eye and the second channel video data D4 for the right eye in memory 30 for the purpose of regulating the timing of outputting the images to and displaying them on the monitor 31 after processing the first channel video data D3 for the left eye and the second channel video data D4 for the right eye for digital/analog conversion.

When an image pickup device 1 adapted to interlaced scanning (FIGS. 1 and 2) is mounted on the video camera 21, the first channel video data D3 for the left eye include odd field video data D3odd and even field video data D3even and the second channel video data D4 for the right eye include odd field video data D4odd and even field video data D4even.

Therefore, the image processing circuit 28 for the monitor outputs the odd field video data D3odd and the even field video data D3even of the first channel video data D3 for the left eye with an interval of 1/120 seconds by way of the digital/analog converter circuit 29 so as to display the image of a frame corresponding to the first channel video data D3 for the left eye with an interval of 1/60 seconds.

On the other hand, the image processing circuit 28 for the monitor outputs the odd field video data D4odd and the even field video data D4even of the second channel video data D4 for the right eye with an interval of 1/120 seconds by way of the digital/analog converter circuit 29 so as to display the image of a frame corresponding to the second channel video data D4 for the right eye with an interval of 1/60 seconds.

In other words, the image processing circuit 28 for the monitor is adapted to output an image of a frame for the left eye corresponding to the first channel video data D3 for the left eye and an image of a frame for the right eye corresponding to the second channel video data D4 for the right eye to the monitor 31 alternately with an interval of 1/60 seconds.

At this time, the microcomputer 27 turns on and off the electronic shutters arranged respectively at the display section 32L for the left eye and the display section 32R for the right eye of the eye-glasses-type stereoscopic image display device 32 alternately with an interval of 1/60 seconds so that the user can visually recognize the image of a frame for the left eye corresponding to the first channel video data D3 for the left eye and image of a frame for the right eye corresponding to the second channel video data D4 for the right eye that are displayed on the monitor 31 with an interval of 1/60 seconds as a stereoscopic image.

When an image pickup device 11 adapted to progressive scanning (FIGS. 3 and 4) is mounted on the video camera 21, the video camera 21 generates a first channel video signal S1 for the left eye (for 525 scanning lines) and a second channel video signal S2 for the right eye (for 525 scanning lines) with an interval of 1/30 seconds simultaneously.

Therefore, the image processing circuit 28 for the monitor outputs the first channel video data D3 for the left eye and the second channel video data D4 for the right eye with an interval of 1/60 seconds by way of the digital/analog converter circuit 29 so as to display the image on the monitor 31.

At this time, the microcomputer 27 turns on and off the electronic shutters arranged respectively at the display section 32L for the left eye and the display section 32R for the right eye of the eye-glasses-type stereoscopic image display device 32 alternately with an interval of 1/60 seconds so that the user can visually recognize the image of a frame for the left eye corresponding to the first channel video data D3 for the left eye and image of a frame for the right eye corresponding to the second channel video data D4 for the right eye that are displayed on the monitor 31 with an interval of 1/60 seconds as a stereoscopic image.

The microcomputer 27 of the stereoscopic image generation device 20 can output either the first channel video data D3 for the left eye or the second channel video data D4 for the right eye to the monitor 31 by way of the live/video switch SW1, the image processing circuit 28 for the monitor and the analog/digital converter circuit 29 so as to display not a stereoscopic image but an ordinary image that corresponds to interlaced scanning or progressive scanning.

### (3) Operation and Advantages

With the above described arrangement, the image pickup device 1 can generate first channel video signals S1 for the left eye (odd field video signals, even field video signals) adapted to interlaced scanning by converging only the horizontal component HL1 of light L1 of the first optical image coming from the subject Q1 and transmitted through the lens 5, the horizontal component polarizing filter 3 and the polarizing filters HF1, HF3, HF5, HF7, HF9, . . . onto the odd first line V1OL1, the even first line V1EL1, the odd second line V1OL2, the even second line V1EL2, . . . for first channel video signals of the imaging plane of the CCD 2.

Additionally, the image pickup device 1 can generate second channel video signals S2 for the right eye (odd field video signals, even field video signals) adapted to interlaced scanning by converging only the vertical component VL2 of light L2 of the second optical image coming from the subject Q1 and transmitted through the lens 6, the vertical component polarizing filter 4 and the polarizing filters HF2, HF4, HF6, HF8, . . . onto the odd first line V2OL1, the even first line V2EL1, the odd second line V2EL2, the even second line V2EL2, . . . for second channel video signals of the imaging plane of the CCD 2.

On the other hand, the image pickup device 11 can generate first channel video signals S1 for the left eye (for 525 scanning lines) adapted to progressive scanning by converging only the horizontal component HL1 of light L1 of the first optical image coming from the subject Q1 and transmitted through the lens 5, the horizontal component polarizing filter 3 and the polarizing filters HF1, HF3, HF5, HF7, HF9, . . . onto the first line V1PL1, the second line V1PL2, the third line V1PL3, the fourth line V1PL4, . . . for first channel video signals of the imaging plane of the CCD 2.

Additionally, the image pickup device 11 can generate second channel video signals S2 for the right eye (for 525 scanning lines) adapted to progressive scanning by converging only the vertical component VL2 of light L2 of the second optical image coming from the subject Q1 and transmitted through the lens 6, the vertical component polarizing filter 4 and the polarizing filters HF2, HF4, HF6, HF8, . . . onto the first line V2PL1, the second line V2PL2, the third line V2PL3, the fourth line V2PL4, . . . for second channel video signals of the imaging plane of the CCD 12.

In this way, the image pickup device 1 or 11 can transmit only the horizontal component HL1 of light L1 of the first optical image from the subject Q1 by means of one of the two polarizing filters separated from each other by a distance corresponding to the parallax of the eyes of the human body, or the horizontal component polarizing filter 3, and subsequently irradiate it onto the imaging plane of the CCD 2 or 12, whichever appropriate, by way of the polarizing filers HF1, HF3, HF5, HF7, HF9, . . . .

At the same time, the image pickup device 1 or 11 can transmit only the vertical component VL2 of light L2 of the second optical image from the subject Q1 by means of the other one of the two polarizing filters separated from each other by a distance corresponding to the parallax of the eyes of the human body, or the vertical component polarizing filter 4, and subsequently irradiate it onto the imaging plane of the CCD 2 or 12, whichever appropriate, by way of the polarizing filers HF2, HF4, HF6, HF8, . . . .

Thus, the image pickup device 1 or 11 can generate first channel video signals S1 for the left eye, using only the horizontal component HL1 of light L1 of the first optical image from the subject Q1, and second channel video signals S2 for the right eye, using only the vertical component VL2 of light L2 of the second optical image from the subject Q1, by means of only a single CCD 2 or 12, whichever appropriate.

Therefore, as the subject Q1 is shot by the video camera 21 on which the image pickup device 1 or 11 is mounted, the stereoscopic image generation device 20 at the same time can alternately display the first channel video signals S1 for the left eye and the second channel video signals S2 for the right eye that are generated by the image pickup device on the monitor 31 with an interval of 1/60 seconds by way of the analog/digital converter circuits 22, 23, the image processing circuit 28 for the monitor and the digital/analog converter circuit 29.

At the same time, the stereoscopic image generation device 20 can cause the user to visually recognize the image for the left eye and the image for the right eye that are displayed on the monitor 31 with an interval of 1/60 seconds as a stereoscopic image by turning on and off the electronic shutters arranged respectively at the display section 32L for the left eye and the display section 32R for the right eye of the eye-glasses-type stereoscopic image display device 32 alternately with an interval of 1/60 seconds.

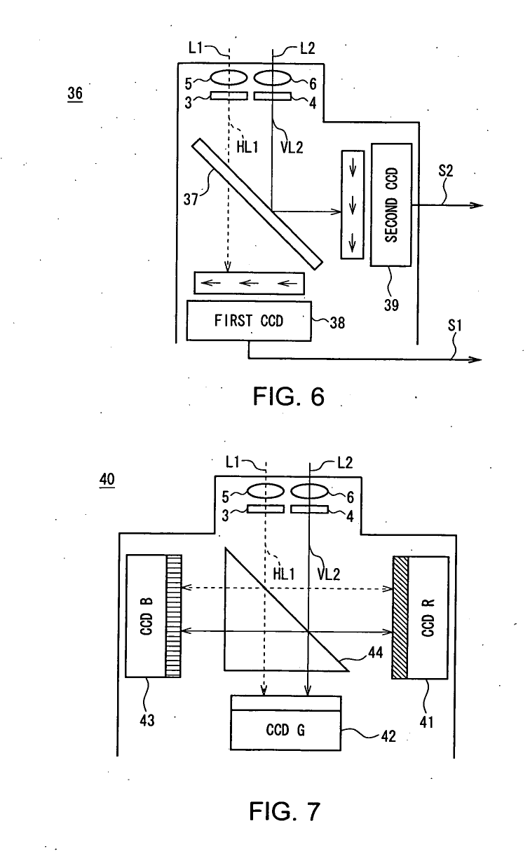

To the contrary, with the conventional image pickup device 36 shown in FIG. 6, in which the components corresponding to those of FIG. 1 are denoted respectively by the same reference symbols, it is impossible to generate first channel video signals S1 for the left eye and second channel video signals S2 for the right eye unless light L1 of the first optical image and light L2 of the second optical image from the subject Q1 are irradiated respectively onto the first CCD 38 and the second CCD 39 by way of beam splitter 37.

On the other hand, with the image pickup device 1 or 11 according to the invention, both first channel video signals S1 for the left eye and second channel video signals S2 for the right eye can be generated by a single CCD 2 or 12 so that the image pickup device can be made to show a simplified configuration and a remarkably downsized profile and reliably reduce the power consumption rate if compared with the conventional image pickup device 36.

Additionally, the horizontal component polarizing filter 3 and the vertical component polarizing filter 4 are separated from each other by a distance corresponding to the parallax of the eyes of the human body and only a single CCD 2 or 12 is provided in the image pickup device 1 or 11. Therefore, unlike the prior art with which the user has to use two video cameras for generating a stereoscopic image, the user of the image pickup device is not forced to do cumbersome operations in order adjust the cameras for focal distance, aperture, zooming, color tone, brightness and other items nor care about the variances of performance of the two cameras when generating first channel video signals S1 for the left eye and second channel video signals S2 for the right eye for a stereoscopic image.

Thus, with the above described arrangement, the image pickup device 1 or 11 can generate first channel video signals S1 for the left eye and second channel video signals S2 for the right eye by means of a single CCD 2 or 12, whichever appropriate, by irradiating only the horizontal component HL1 of light L1 of the first optical image and the vertical component VL2 of light L2 of the second optical image onto the imaging plane of the CCD 2 o 12 respectively by way of the horizontal component polarizing filter 3 and the vertical component polarizing filter 4 that are separated from each other by a distance corresponding to the parallax of the eyes of the human body and the polarizing filters HF1, HF3, HF5, HF7, HF9, . . . that correspond to the horizontal component polarizing filter 3 and the polarizing filters HF2, HF4, HF6, HF8, . . . that correspond to the vertical component polarizing filter 4.

The stereoscopic image generation device 20 can cause the user to visually recognize the image for the left eye and the image for the right eye based on first channel video signals S1 for the left eye and second channel video signals S2 for the right eye that are generated by means of the image pickup device 1 or 11 and displayed on the monitor 31 with a predetermined time interval as a stereoscopic image when the user watches the monitor 31 by way of the stereoscopic image display device 32.

### (4) Other Embodiments

While the image pickup device 1 or 11 is adapted to generate first channel video signals S1 for the left eye and second channel video signals S2 for the right eye by means of a single CCD 2 or 12, whichever appropriate, in the above description of the embodiment, the present invention is by no means limited thereto. Alternatively, it may be so arranged that first channel video signals S1 for the left eye and second channel video signals S2 for the right eye are generated by means of three CCDs for R (red), G (green) and B (blue), or a 3-CCD type image pickup device.

Then, as shown in FIG. 7, where the components corresponding to their counterparts of FIG. 1 are denoted respectively by the same reference symbols, the 3-CCD type image pickup device 40 comprises three CCDs including a CCD 41 for R (red color), a CCD 42 for G (green color) and a CCD 43 for B (blue color), which are arranged around a central beam splitter 44, and the horizontal component HL1 of light L1 of the first optical image and the vertical component VL2 of light L2 of the second optical image that are transmitted respectively by way of a horizontal component polarizing filter 3 and a vertical component polarizing filter 4 that are separated from each other by a distance corresponding to the parallax of the eyes of the human body are projected onto the CCD 41 for red color, the CCD 42 for green color and CCD 43 for blue color.

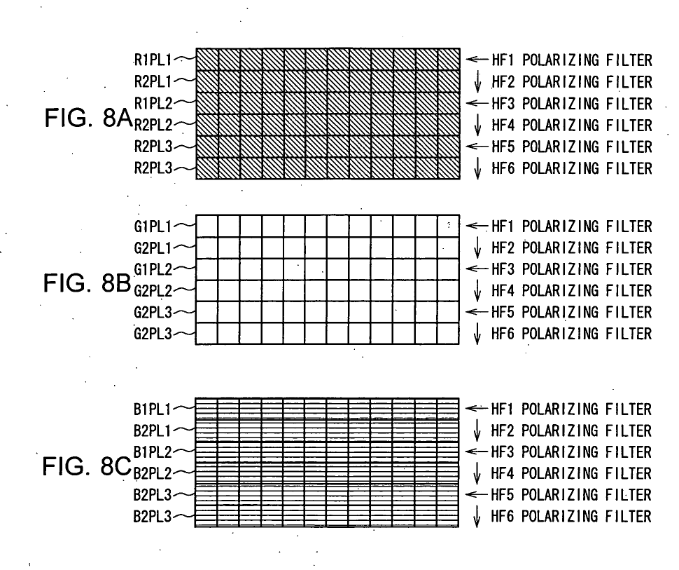

As shown in FIGS. 8A, 8B and 8C, the CCD 41 for red color, the CCD 42 for green color and the CCD 43 for blue color comprise respective solid state image pickup devices that are adapted to progressive scanning and have pixels corresponding to scanning lines (1050) twice as many as the number of scanning lines (525) of the NTSC system. Red, green and blue color filters are arranged in front of all the pixels.

In the CCD 41 for red color, the first line R1PL1 for first channel video signals, the first line R1PL2 for first channel video signals, the first line R1PL3 for first channel video signals, . . . , which are every other scanning lines in the above described line arrangement, are pixel lines corresponding to first channel video signals for the left eye and adapted to progressive scanning, while the first line R2PL1 for second channel video signals, the second line R2PL2 for second channel video signals, the third line R2PL3 for second channel video signals, . . . , which are every other scanning lines in the above described line arrangement, are pixel lines corresponding to second channel video signals for the right eye and adapted to progressive scanning.

In the CCD 42 for green color, the first line G1PL1 for first channel video signals, the first line G1PL2 for first channel video signals, the first line G1PL3 for first channel video signals, . . . , which are every other scanning lines in the above described line arrangement, are pixel lines corresponding to first channel video signals for the left eye and adapted to progressive scanning, while the first line G2PL1 for second channel video signals, the second line G2PL2 for second channel video signals, the third line G2PL3 for second channel video signals, . . . , which are every other scanning lines in the above described line arrangement, are pixel lines corresponding to second channel video signals for the right eye and adapted to progressive scanning.

In the CCD 43 for blue color, the first line B1PL1 for first channel video signals, the first line B1PL2 for first channel video signals, the firstly B1PL3 for first channel video signals, . . . , which are every other scanning lines in the above described line arrangement, are pixel lines corresponding to first channel video signals for the left eye and adapted to progressive scanning, while the second line B2PL1 for second channel video signals, the second line B2PL2 for second channel video signals, the second line B2PL3 for second channel video signals, . . . , which are every other scanning lines in the above described line arrangement, are pixel lines corresponding to second channel videos for the right eye and adapted to progressive scanning.

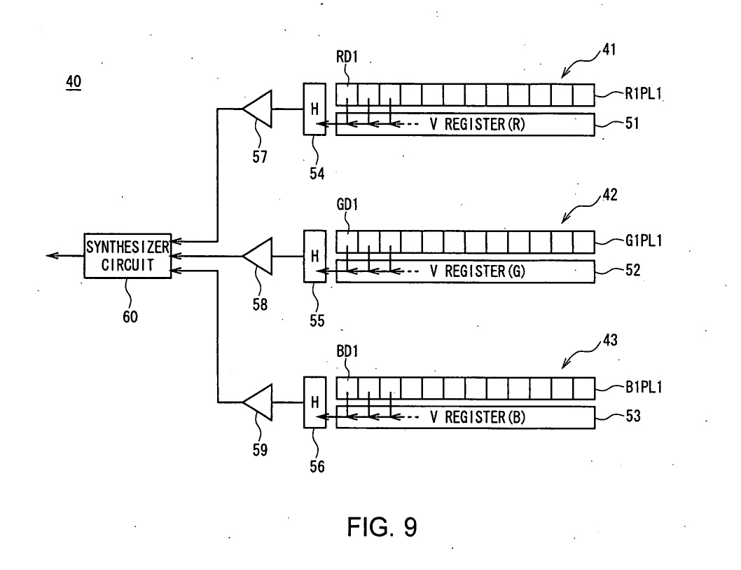

As shown in FIG. 9, the image pickup device 40 synthesizes the first pixel data RD1 of the first line R1PL1 of the CCD 41 for red color, the first pixel data GD1 of the first line G1PL1 of the CCD 42 for green color and the first pixel data BD1 of the first line B1PL1 of the CCD 43 for blue color coming respectively by way of V registers 51 through 53, H registers 54 through 56 and amplifiers 57 through 59 by means of synthesizer circuit 60, using the formulas

Y=0.59G+0.3R+0.11B (1)

R−Y=0.7(R−G)−0.11(B−G) (2)

B−Y=0.89(B−G)−0.3(R−G) (3)

to generate luminance signal Y and color difference signals R −Y and B−Y and outputs these signals as the first pixel signal of first channel video signals for the first line.

In this way, the image pickup device 40 generates luminance signal Y and color difference signals R−Y and B−Y of first channel video signals and those of second channel video signals for each pixel by performing computing operations using the formulas (1) through (3) and outputs the generated signals on a pixel by pixel basis.

As a result, it is possible with the 3-CCD type (3-plate type) image pickup device 40 to improve the color reproducibility and other characteristic features in order to produce high quality images if compared with the single plate type image pickup device 1 or 11 comprising only a single CCD 2 or 12, in which three pixels are used to form a pixel of a color image. The above description of the CCD 2 of FIG. 1 can be applied to this embodiment when rectangular 2-phase modulation is performed on the color difference signals R−Y and B−Y to obtain a composite signal.

While the horizontal component polarizing filter 3 and the vertical component polarizing filter 4 of the image pickup device 1 or 11 are separated from each other by a distance corresponding to the parallax of the eyes of the human body in the above description of embodiments, the present invention is by no means limited thereto. For example, the two filters may be separated from each other by an appropriate distance and inclined relative to each other by a predetermined angle to generate video signals for two channels over a wide angle.

While a CCD 2 or 12 having pixels that correspond to scanning lines twice as many as the scanning lines of the NTSC system is used in order to generate first channel video signals S1 for the left eye and second channel video signals S2 for the right eye in the above description of embodiments, the present invention is by no means limited thereto. For example, a CCD having pixels corresponding to scanning lines integer (n) times as many as the scanning lines of the NTSC system may be used in order to generate video signals for n channels, where n may typically be equal to four. In this case, n polarizing filters need to be used in order to generate video signals for n channels.

While a CCD 2 or 12 having pixels that correspond to scanning lines twice as many as the scanning lines of the NTSC system is used in order to generate first channel video signals S1 for the left eye and second channel video signals S2 for the right eye in the above description of embodiments, the present invention is by no means limited thereto. For example, first channel video signals for the left eye and second channel video signals for the right eye may be generated by assigning the odd fields to first channel video signals for the left eye and the even fields to second channel video signals for the right eye without increasing the number of scanning lines.

While first channel video data D3 for the left eye and second channel video data D4 for the right eye are displayed on the monitor 31 alternately with intervals of 1/60 seconds as a result of alternately outputting odd field video data D3odd and even field video data D3even of first channel video data D3 for the left eye and odd field video data D4odd and even field video data D4even of second channel video data D4 with intervals of 1/120 seconds by means of a CCD 2 adapted to interlaced scanning in the above description of embodiments, the present invention is by no means limited thereto. For example, it may alternatively be so arranged that odd field video data D3odd of first channel video data D3 for the left eye and even field video data D4even of second channel video data D4 for the right eye are alternately output with intervals of 1/60 seconds. In other words, even field video data D3even of first channel video data D3 for the left eye and odd field video data D4odd of second channel video data D4 for the right eye may be discarded without being output.

While a CCD 2 or 12 having pixels that correspond to scanning lines (1050) twice as many as the scanning lines (525) of the NTSC system is used in the above description of embodiments, the present invention is by no means limited thereto. For example, a CCD having pixels that correspond to scanning lines (1250) twice as many as the scanning lines (625) of the phase alternation by line color television (PAL) system or séquential couleur à mémoire (SECAM) system or a CCD having pixels or lines that correspond to extended graphics array (XGA) or super extended graphics array (SXGA) may alternatively be used.

While the first channel video signals S1 for the left eye and the second channel video signals S2 for the right eye generated by the image pickup device 1 or 11 are used to display a stereoscopic image in the above description of embodiments, the present invention is not limited thereto and the distance to the subject may be measured by using first channel video signals S1 and second channel video signals S2. In other words, video signals of a plurality of channels may be used to purposes other than displaying stereoscopic images.

While the polarizing filters HF1, HF3, HF5, HF7, HF9, . . . adapted to transmit only the horizontal component HL1 of light L1 of the first optical image are arranged for every other scanning lines of the imaging plane of the CCD 2 or 12 and the polarizing filters HF2, HF4, HF6, HF8, . . . adapted to transmit only the vertical component VL2 of light L2 of the second optical image are arranged for every other scanning lines of the imaging plane of the CCD 2 or 12, whichever appropriate, in the above description of embodiments, the present invention is by no means limited thereto. For example, the polarizing filters HF1, HF3, HF5, HF7, HF9, . . . adapted to transmit only the horizontal component HL1 of light L1 of the first optical image are arranged for the upper half region of the imaging plane of the CCD 2 or 12 and the polarizing filters HF2, HF4, HF6, HF8, . . . adapted to transmit only the vertical component VL2 of light L2 of the second optical image are arranged for the lower half region of the imaging plane of the CCD 2 or 12, whichever appropriate.

Finally, while an image pickup device according to the invention comprises a CCD 2 or 11 as image pickup means, a horizontal component polarizing filter 3 as first horizontal component polarizing means and a vertical component polarizing filter 4 as first vertical component polarizing means in the above description of embodiments, the present invention is by no means limited thereto. An image pickup device according to the invention may alternatively comprise any other image pickup means, any other first horizontal component polarizing means and any other first vertical component polarizing means.

As described above in detail, according to the invention, video signals of channels that correspond only to light of the first optical image and that of the second optical image can be generated by converging the horizontal component transmitted by the first horizontal component polarizing means to the pixels in a predetermined area on the imaging plane of the image pickup means and converging the vertical component transmitted by the first vertical component polarizing means to the pixels in the remaining area of the imaging plane of the image pickup means excluded from the predetermined area. With this arrangement, it is possible to realize an image pickup device having a simple configuration and adapted to generate video signals of a plurality of channels in a manner easy to the user.

According to the invention, video signals for the left eye and video signals for the right eye can be used to display a stereoscopic image by generating the video signals for the left eye and the video signals for the right eye corresponding respectively to light of the first optical image and that of second optical image, performing a predetermined processing operation on the video signals for the left eye and the video signals for the right eye and then alternately outputting the video signals for the left eye and the video signals for the right eye by switching from the former to the latter and vice versa at predetermined time intervals when the horizontal component transmitted by the first horizontal component polarizing means is converged to the pixels in a predetermined area on the imaging plane of the image pickup means and the vertical component transmitted by the first vertical component polarizing means is converged to the pixels in the remaining area of the imaging plane of the image pickup means excluded from the predetermined area. With this arrangement, it is possible to realize a stereoscopic image generation device having a simple configuration and adapted to generate a stereoscopic image in a manner easy to the user.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

What is claimed is:

1. An image pickup device comprising:
image pickup means having pixels arranged on an imaging plane to the number corresponding to integer times of a predetermined number of scanning lines;
first horizontal component polarizing means adapted to transmit the horizontal component of light of a first optical image from a subject; and
first vertical component polarizing means arranged at a position separated from the first horizontal component polarizing means by a predetermined distance and adapted to transmit the vertical component of light of a second optical image from the subject, wherein:
the horizontal component transmitted by the first horizontal component polarizing means is converged to the pixels in a predetermined area on the imaging plane; and
the vertical component transmitted by the first vertical component polarizing means is converged to the pixels in the remaining area excluded from the predetermined area.

2. The image pickup device according to claim 1, wherein:
the pixels in the predetermined area on the imaging plane are pixels corresponding to very other scanning lines; and
the pixels in the remaining area excluded from the predetermined area on the imaging plane are pixels corresponding to the remaining scanning lines.

3. The image pickup device according to claim 1, wherein
the image pickup means generates video signals for the left eye to be used for forming a stereoscopic image as the horizontal component of light of the first optical image is converged to the pixels of the predetermined area and video signals for the right eye to be used for forming the stereoscopic image as the vertical component of light of the second optical image is converged to the pixels of the remaining area.

4. The image pickup device according to claim 1, further comprising
color filters of red, green and blue or those of cyan, magenta and yellow that are complementary colors of the former colors arranged in front of all the pixels that correspond to integer times of the scanning lines.

5. A stereoscopic image generation device comprising:
an image pickup device comprising:
image pickup means having pixels arranged on an imaging plane to the number corresponding to integer times of a predetermined number of scanning lines; and
first horizontal component polarizing means adapted to transmit the horizontal component of light of the first optical image from a subject for generating video signals for the left eye and first vertical component polarizing means arranged at a position separated from the first horizontal component polarizing means by a predetermined distance and adapted to transmit the vertical component of light of the second optical image from the subject for generating video signals for the right eye, wherein:
the horizontal component transmitted by the first horizontal component polarizing means is converged to the pixels in a predetermined area on the imaging plane; and
the vertical component transmitted by the first vertical component polarizing means is converged to the pixels in the remaining area excluded from the predetermined area;
signal processing means for processing the video signals for the left eye and the video signals for the right eye generated by the image pickup device in order to display an image on a predetermined display section by means of the signals; and
control means for alternately outputting the video signals for the left eye and the video signals for the right eye as processed by the signal processing means for a stereoscopic image by switching from the former to the latter and vice versa at predetermined time intervals.
